(19) United States
(12) Patent Application Publication
(10) Pub. No.: US 2017/0315557 A1
(43) Pub. Date: Nov. 2, 2017

(54) CHARGING SYSTEM FOR AUTONOMOUS VEHICLES

(71) Applicant: GM GLOBAL TECHNOLOGY OPERATIONS LLC, Detroit, MI (US)

(72) Inventors: Kyle Vogt, San Francisco, CA (US); Divya Thakur, San Francisco, CA (US)

(73) Assignee: GM GLOBAL TECHNOLOGY OPERATIONS LLC, Detroit, MI (US)

(21) Appl. No.: 15/655,172

(22) Filed: Jul. 20, 2017

(51) Int. Cl. G05D 1/02; G05D 1/00; B60L 11/18; B60R 16/023

(52) U.S. Cl. CPC G05D 1/0225; G05D 1/0274; G05D 1/0242; G05D 1/0238; B60L 11/1844; B60R 16/0231; G05D 1/0011; B60L 2240/72; B60L 2260/54

(57) ABSTRACT

Systems and method are provided for charging batteries of a vehicle. In one embodiment, a method includes: determining, by a processor, a state of charge of batteries of the vehicle; autonomously controlling, by a processor, the vehicle to a slot of a charging station based on the state of charge; and communicating, by a processor, with the charging station to coordinate autonomous charging of the batteries of the vehicle.

### INTRODUCTION

The present disclosure generally relates to autonomous vehicles, and more particularly relates to systems and methods for automatically charging an autonomous vehicle when a state of charge of a battery of the autonomous vehicle is low.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

While autonomous vehicles and semi-autonomous vehicles offer many potential advantages over traditional vehicles, in certain circumstances it may be desirable for improved operation of the vehicles. For example, some autonomous vehicles are electric or hybrid electric vehicles that include at least one battery. After extended use of the electric or hybrid electric vehicle, the state of charge of the battery may become low and need to be recharged. Accordingly, it is desirable to provide systems and methods that identify a low state of charge of a battery of the vehicle, and automatically charge the battery. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for charging batteries of a vehicle. In one embodiment, a method includes: determining, by a processor, a state of charge of batteries of the vehicle; autonomously controlling, by a processor, the vehicle to a slot of a charging station based on the state of charge; and communicating, by a processor, with the charging station to coordinate autonomous charging of the batteries of the vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having an autonomous charging system, in accordance with various embodiments;

FIG. 2 is a functional block diagram illustrating a transportation system having one or more autonomous vehicles of FIG. 1 and at least one charging station, in accordance with various embodiments;

FIG. 3 is an illustration of the charging station, in accordance with various embodiments;

FIGS. 4, 5, and 6 are dataflow diagrams illustrating an autonomous driving system and an autonomous charging system, in accordance with various embodiments; and

FIGS. 7 and 8 are flowcharts illustrating control methods for controlling the autonomous vehicle and an extension arm of the charging station, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

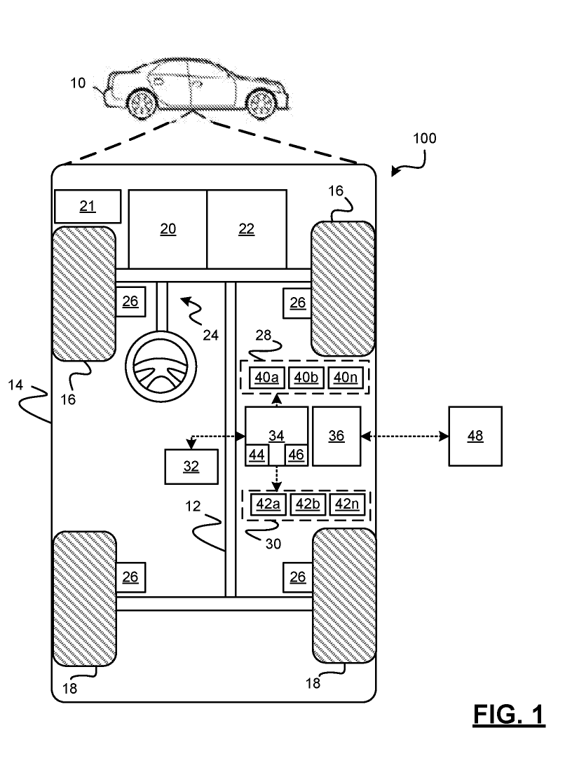

With reference to FIG. 1, an autonomous charging system shown generally at 100 is associated with a vehicle 10 in accordance with various embodiments. In general, the autonomous charging system 100 receives and processes sensor data to determine when a state of charge of a battery of the vehicle 10 is low (e.g., below a predefined threshold). As will be discussed in more detail below, the autonomous charging system 100 automatically charges the low battery by seeking out an available charging station and slot of the charging station and automatically controlling the vehicle 10 and/or components of the vehicle 10 such that the vehicle 10 navigates to the charging slot of the charging station and connects with a charging system. The autonomous charging system 100 detects completion of the charging and automatically controls the vehicle 10 to a ready state such that it can navigate away from the charging slot of the charging station.

As depicted in the example of FIG. 1, the vehicle 10 is an automobile and generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the autonomous charging system 100 described herein is incorporated into the autonomous vehicle (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an autonomous driving system of all aspects of the dynamic driving task, even if a human driver does not respond appropriately to a request to intervene. A Level Five system indicates “full automation”, referring to the full-time performance by an autonomous driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20, in various embodiments, includes an electric machine, such as a traction motor powered by one or more batteries, alone (e.g., as a pure electric vehicle) or in combination with an internal combustion engine and/or a fuel cell propulsion system (e.g., as a hybrid electric vehicle). The batteries of the propulsion system 20 are associated with a battery management system 21 having a port that provides charging access to the batteries through, for example, the body 14 of the vehicle 10. In various embodiments, the port may be accessed by way of a door or cover coupled to the body 14 of the vehicle 10.

The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. In various embodiments, the sensor system 28 further includes one or more sensing devices 41a-41n that sense observable conditions of one or more vehicle components. For example, at least one sensing device 41a senses chemical properties, voltage, current, and/or other properties of the batteries of the propulsion system 20. The sensor measurements are then used to estimate a state of charge of the batteries.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

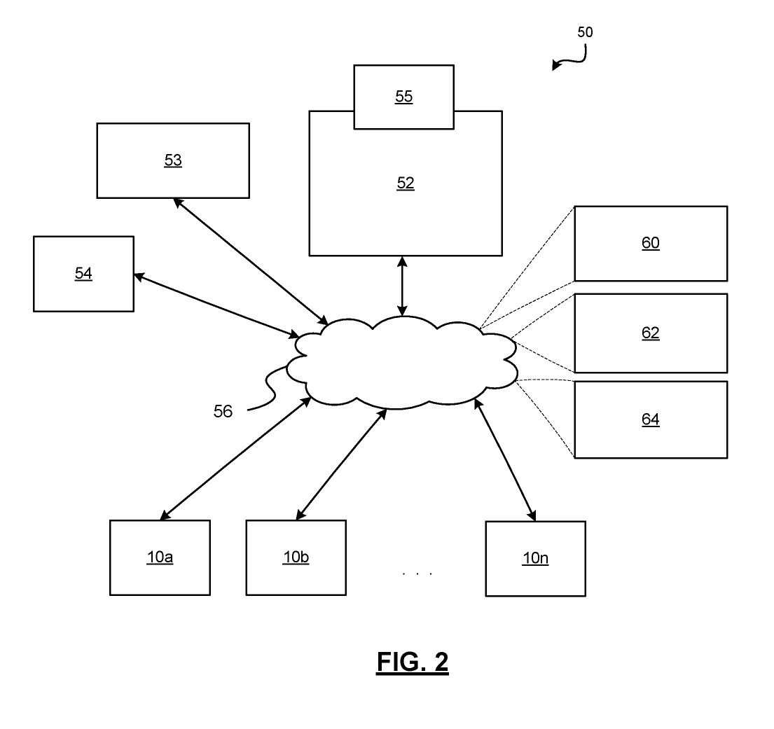

The communication system 36 is configured to wirelessly communicate information to and from other entities 48, such as but not limited to, other vehicles (“V2V” communication,) infrastructure (“V2I” communication), remote systems, charging stations, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement the autonomous charging systems and methods as discussed in detail below.

The instructions of the controller 34 may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. The operating environment 50 includes one or more charging stations 53 that are accessible by the autonomous vehicles 10a-10n for autonomously charging the autonomous vehicles 10a-10n.

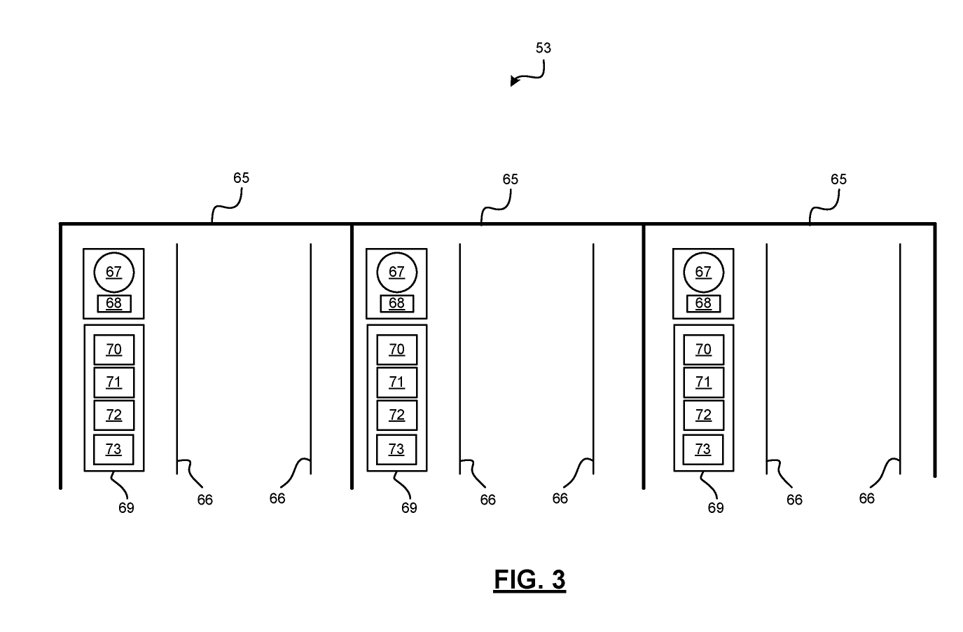

For example, as shown in more detail in FIG. 3, an exemplary charging station 53 includes one or more slots 65. Each slot 65 includes positioning devices 66, such as a set of tracks or rails or other markings, for physically or visually guiding the autonomous vehicles 10a-10n into a charging position. Each slot 65 further includes a power supply 67 associated with or more connector devices 68. The one or more connector devices 68 are coupleable to the port of the battery management system 21 of the vehicles 10a-10n. The power supply 67 provides, for example, high voltage direct current to the batteries when the connector device 68 is coupled to a port of a vehicle.

Each slot 65 further includes a programmable machine 69 having an extension arm 70 and one or more sensors 73. The extension arm 70 is autonomously controlled to interact with the vehicles 10a-10n and the power supply 67. For example, the extension arm 70 includes any number of links that are coupled by joints that allow for rotational motion and/or translational displacement. The extension arm may further include an end effector having at least two finger grippers for interacting with the vehicle 10 and the connector device 68. The sensors 73 sense observable conditions associated with the vehicle 10 and the extension arm 70. For example, the sensors 73 may include image sensors or the like that capture images associated with the movement and location of the extension arm 70 relative to the vehicle and/or environment.

The programmable machine 69 includes at least one processor 71 and a computer readable storage device or media 72. The processor 71 can be any custom made or commercially available processor, a central processing unit (CPU), a graphics processing unit (GPU), an auxiliary processor among several processors, a semiconductor based microprocessor (in the form of a microchip or chip set), a macroprocessor, any combination thereof, or generally any device for executing instructions. The computer readable storage device or media 72 may include volatile and nonvolatile storage in read-only memory (ROM), random-access memory (RAM), and keep-alive memory (KAM), for example. KAM is a persistent or non-volatile memory that may be used to store various operating variables while the processor 71 is powered down. The computer-readable storage device or media 72 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the programmable machine 69 in controlling the extension arm 70. In various embodiments, the programmable machine 69 is configured to implement charging station systems and methods as discussed in detail below.

For example, the instructions may include one or more separate programs, each of which comprises an ordered listing of executable instructions for implementing logical functions. The instructions, when executed by the processor 71, communicate with the vehicles 10a-10n and/or the remote transportation system 52 (FIG. 2), generate control signals to control the extension arm 70, and receive and process sensor data from sensors 73 associated with the extension arm 70.

With reference back to FIG. 2, in various embodiments, the operating environment 50 further includes one or more user devices 54 that communicate with the autonomous vehicle 10 and/or the remote transportation system 52 via a communication network 56. The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an autonomous advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In various embodiments, the remote transportation system 52 includes a reservation system 55 that communicates with the autonomous vehicles 10a-10n to create a schedule of charging times for each of the charging slots 65 of the charging stations 53. The schedule and charging times are determined based on information communicated by the vehicles 10a-10n to the remote transportation system 52 such as, but not limited to, a current vehicle location, a current state of charge of the battery of the vehicle, a type or number of batteries of the vehicle, a current rout of the vehicle, etc.

As can be appreciated, the subject matter disclosed herein provides certain enhanced features and functionality to what may be considered as a standard or baseline autonomous vehicle and/or an autonomous vehicle based remote transportation system. To this end, an autonomous vehicle and autonomous vehicle based remote transportation system can be modified, enhanced, or otherwise supplemented to provide the additional features described in more detail below.

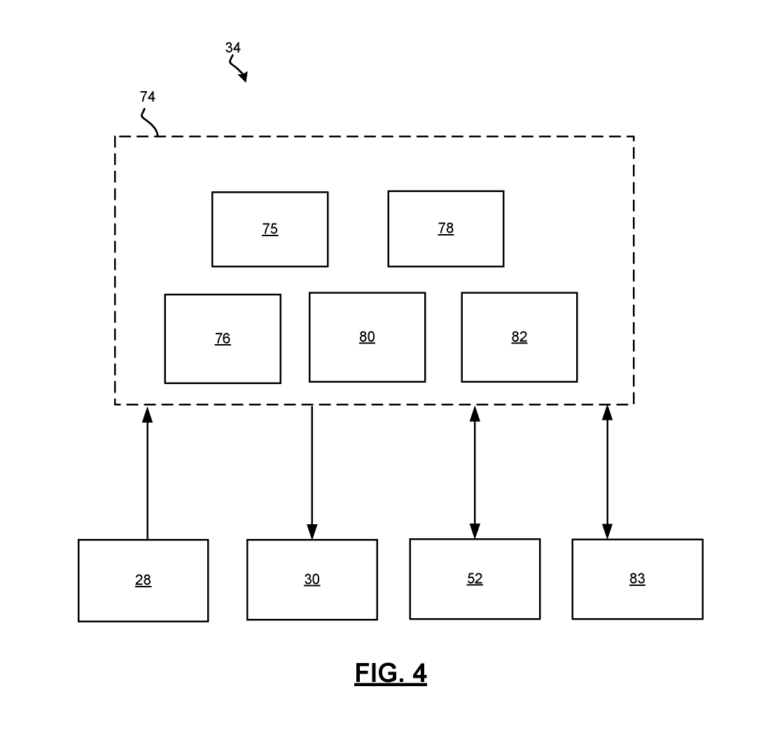

In accordance with various embodiments, the controller 34 implements an autonomous driving system (ADS) 74 as shown in FIG. 4. That is, suitable software and/or hardware components of the controller 34 (e.g., the processor 44 and the computer-readable storage device 46) are utilized to provide an autonomous driving system 74 that is used in conjunction with vehicle 10.

In various embodiments, the instructions of the autonomous driving system 74 may be organized by function, module, or system. For example, as shown in FIG. 4, the autonomous driving system 74 can include a computer vision system 75, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 75 synthesizes and processes sensor data and predicts the presence, location, classification, and/or path of objects and features of the environment of the vehicle 10. In various embodiments, the computer vision system 75 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, part of the autonomous charging system 100 of FIG. 1 is included within the ADS 74, for example, as a vehicle side autonomous charging system 82. In particular, the vehicle side autonomous charging system 82 receives information from the sensor system 28 to determine the state of charge of the battery, communicates with the remote transportation system 52 to find and schedule a charging time with a charging station 53, and communicates a location and/or a desired route to the guidance system 78 to initiate autonomous control of the vehicle 10. Once the vehicle 10 has navigated to the slot 65 of the charging station 53, the vehicle autonomous charging system 82 communicates with a charging station system 83 to initiate and confirm charging of the batteries.

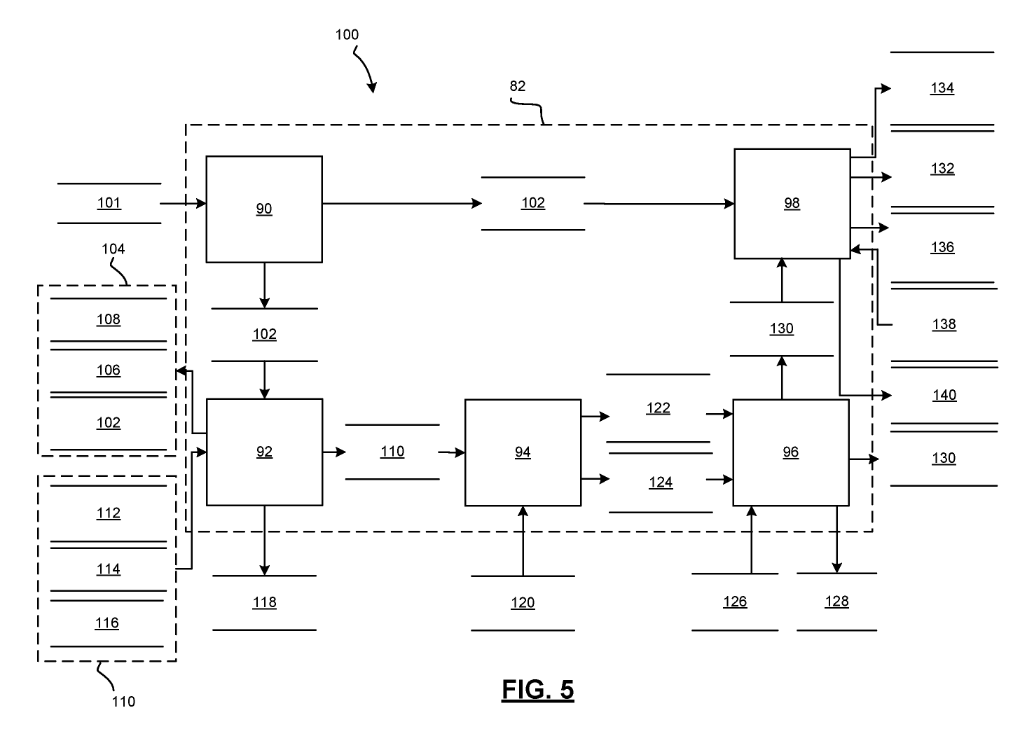

As shown in more detail with regard to FIG. 5 and with continued reference to FIG. 4, the vehicle side autonomous charging system 82 includes a battery state of charge detection module 90, a charging location reservation module 92, a location confirmation module 94, a slot position confirmation module 96, and a charging confirmation module 98. The battery state of charge detection module 90 monitors sensed and/or other battery related data 101 and determines a state of charge 102 of the batteries. As can be appreciated, various methods can be used to determine the state of charge 102, depending on the type of batteries of the vehicle 10 and/or the data sensed from the batteries. The present disclosure is not limited to any one method.

The charging location reservation module 92 monitors the state of charge 102 and determines when charging of the batteries is needed. For example, the charging location reservation module 92 determines when a charge is needed based on a comparison of the state of charge 102 to a threshold. In various embodiments, the threshold may be predefined (e.g., 30%, or other value). In various other embodiments, the threshold may be dynamically determined, for example based on a location of the vehicle 10 relative to available charging stations 53, based on a route of the vehicle 10, and/or based on predicted battery usage during a route.

When the charging location reservation module 92 determines that a charge is needed, the charging location reservation module 92 communicates a request to charge 104 to the reservation system 55 of the remote transportation system 52. In various embodiments, the request to charge 104 includes at least a current location 106 of the vehicle 10, the state of charge 102, and optionally an upcoming route 108 of the vehicle 10. The location reservation module 92 receives from the reservation system 55, in return, confirmation data 110. In various embodiments, the confirmation data 110 includes a charging station location 112, a slot location 114, and a charging time 116 (e.g., a beginning time, a beginning and an ending time, etc.). Based, on the confirmation data 110, the charging location reservation module 92 communicates the charging station location 112 and the slot location 114 to the guidance system 78 as a desired location 118 for controlling of the vehicle 10 to the location of the charging station 53 and to the correct slot 65.

The location confirmation module 94 receives the confirmation data 110 and an actual location 120 of the vehicle 10 and confirms when the vehicle 10 has reached the location of the charging station 53 and the slot 65. For example, the location confirmation module 94 monitors the actual location 120 and generates a charging location confirmation 122 when the actual location 120 reaches (e.g., coordinates are equal to or within a range of) the charging station location 112. In another example, the location confirmation module 94 further monitors the actual location 120 and generates a slot location confirmation 124 when the actual location 120 reaches (e.g., coordinates are equal to or within a range of) the slot location 114.

The slot position confirmation module 96 receives the charging location confirmation 122, the slot location confirmation 124, and sensor data 126 generated by the sensor system 28 of the vehicle 10. Once the charging location confirmation 122 and the slot location confirmation 124 indicate that the vehicle 10 has reached the charging station 53 and the slot 65, the slot position confirmation module 96 processes the sensor data 126 to confirm that the vehicle 10 has reached an appropriate charging position within the slot 65. In various embodiments, the appropriate charging position can be determined based on a visual and/or physical identification of the positioning devices 66.

When the slot position confirmation module 96 determines that the vehicle 10 has not reached the appropriate charging position, the slot position confirmation module 96 determines a difference 128 between the current position and the appropriate position (e.g., by comparison to a sensed position of the positioning devices 66), and communicates the difference 128 to the guidance system 78 for control of the vehicle 10. Once the slot position confirmation module 96 determines that the vehicle 10 has reached the appropriate charging position, the slot position confirmation module 96 communicates a slot position confirmation 130 to the charging station system 83 to indicate to the charging station system 83 that it may begin the charging process.

Additionally or alternatively, in various embodiments, the charging station system 83 may evaluate the position of the vehicle 10 within the slot 53. For example, a slot position confirmation module of the charging station system 83 may determine a difference between the current position and the appropriate position (e.g., by comparison to a sensed position of positioning devices on the vehicle), and communicate the difference 128 back to the vehicle 10.

The charging confirmation module 98 receives the slot position confirmation 130. Based on the slot position confirmation 130 indicating that the vehicle 10 is in position for charging, the charging confirmation module 98 monitors the state of charge 102 of the batteries to determine if charging has initiated. For example, if a change in the state of charge 102 is greater than a threshold, then the charging confirmation module 98 generates a charging initiated confirmation 132 to the charging station system 83. In another example, if after a predetermined time the change in the state of charge 102 does not exceed the threshold, then the charging confirmation module 98 generates a charging not initiated signal 134 to the charging station system 83 such that the charging station system 83 can evaluate and determine a cause for not charging. As can be appreciated, any number of communications can be made between the charging confirmation module 98 and the charging station system 83 to confirm initiation of the charging.

The charging confirmation module 98 continues to monitor the state of charge 102 until the state of charge 102 reaches a threshold. In various embodiments, the threshold may be predefined, and/or based on the vehicle type, the battery type, and/or the allotted charging time. Once the state of charge 102 reaches the threshold, the charging confirmation module 98 generates a charging complete confirmation 136 that is communicated to the charging station system 83.

The charging confirmation module 98 further receives a cover/door closed confirmation 138 from the charging station system 83 indicating that the connector device 68 has been removed and the cover/door has been closed. Upon receipt of the cover/door closed confirmation 138, optionally, the charging confirmation module 98 performs its own confirmation of the cover/door closed based on sensor data from the sensor system 28. The charging confirmation module 98 then generates a vehicle ready state notification 140 to the guidance system 78 and/or the vehicle control module 80 to cause the vehicle 10 to be controlled to a ready state.

As can be appreciated, various embodiments of the autonomous charging system 100 according to the present disclosure may include any number of additional sub-modules embedded within the controller 34 which may be combined and/or further partitioned to similarly implement systems and methods described herein. Furthermore, inputs to the autonomous charging system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

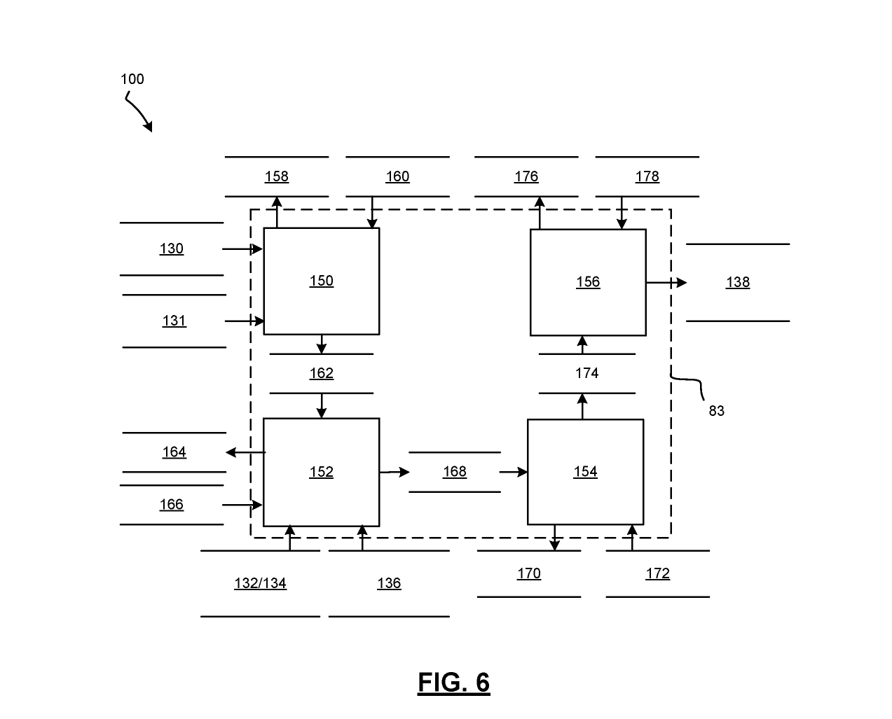

As shown in more detail with regard to FIG. 6 and with continued reference to FIGS. 4 and 5, the charging station system 83 includes a cover/door open control module 150, a connector device insert control module 152, a connector device remove control module 154, and a cover/door close control module 156.

The cover/door open control module 150 receives the slot position confirmation 130, and optionally the vehicle identifier 131 communicated by the vehicle autonomous charging system 82. The cover/door open control module 150 generates one or more control signals 158 and sends them to the extension arm 70 to cause the extension arm 70 to open the cover/door. In various embodiments, the cover/door open control module 150 generates the control signals 158 once the vehicle identifier has been verified (e.g., for the charging time). The cover/door control module 150 further receives sensor data 160 from one or more sensors of the charging station 53 and processes the sensor data 160 to determine if the cover/door is in fact open and the charging port is accessible. For example, the sensor data 160 can include image data, and the image data can be compared to stored image data defining an open cover/door to confirm whether the cover/door is open and the charging port is accessible. As can be appreciated, if it is determined that the cover/door is not yet open or the charging port is still not accessible, subsequent control signals 158 may be generated to cause the extension arm 70 to further open the cover/door. Once it is determined that the cover/door is open and the charging port is accessible, a confirmation 162 of the cover/door is generated.

The connector device insert control module 152 receives the confirmation 162 and optionally the vehicle identifier 131. When the confirmation 162 indicates that the cover/door is open, the connector device insert control module 152 generates one or more control signals 164 to the extension arm 70 to cause the extension arm 70 to select the connector device 68 (e.g., if more than one connector device 68, then selection is based on the vehicle identifier 131). The connector device insert control module 152 further generates control signals to cause the extension arm 70 to insert the connector device 68 into the charging port.

The connector device insert control module 152 further receives sensor data 166 from one or more sensors of the charging station 53 and processes the sensor data 166 to determine if the connector device 68 has been inserted into the port. For example, the sensor data 166 can include image data, and the image data can be compared to stored image data defining a connector device inserted into the port. As can be appreciated, if it is determined that the connector device 68 is not inserted into the port, subsequent control signals 164 may be generated to cause the extension arm 70 to remove and/or further insert the connector device 68.

Once it is determined that the connector device 68 is inserted, the connector device insert control module 152 monitors for the confirmation 132/134 that the charging is or is not initiated. If the charging is not initiated, the connector device control module 152 optionally generates follow-up communications to the charging station system 83 and/or the remote transportation system 52 to initiate diagnostics and/or reschedule a charging time and/or slot.

If the charging is initiated, the connector device insert control module 152 waits for a charging complete confirmation 136. Once the charging complete confirmation 136 is received, the connector device insert control module 152 generates a confirmation 168 that the charging is complete.

The connector device remove control module 154 receives the confirmation 168. When the confirmation 168 indicates that the charging is complete, the connector device remove control module 154 generates one or more control signals 170 to the extension arm 70 to cause the extension arm 70 to remove the connector device 68 from the charging port. The connector device remove control module 152 further receives sensor data 172 from one or more sensors of the charging station 53 and processes the sensor data 172 to determine if the connector device 68 has been removed from the port. For example, the sensor data 172 can include image data, and the image data can be compared to stored image data defining a connector device 68 removed from the port. As can be appreciated, if it is determined that the connector device 68 is not removed from the port, subsequent control signals 170 may be generated to cause the extension arm 70 to further remove the connector device 68. Once it is determined that the connector device 68 is removed, the connector device remove control module 154 generates a confirmation 174 indicating that the connector device 68 is removed.

The cover/door close control module 156 receives the slot position confirmation 130, and optionally the vehicle identifier 131 communicated by the vehicle autonomous charging system 82. The cover/door close control module 156 generates one or more control signals 176 to the extension arm 70 to cause the extension arm 70 to open the cover/door. The cover/door close control module 156 further receives sensor data 178 from one or more sensors of the charging station 53 and processes the sensor data 178 to determine if the cover/door is in fact closed. For example, the sensor data 178 can include image data, and the image data can be compared to stored image data defining a closed cover/door to confirm whether the cover/door is closed. As can be appreciated, if it is determined that the cover/door is not yet closed, subsequent control signals 176 may be generated to cause the extension arm 70 to further close the cover/door. Once it is determined that the cover/door is closed, the confirmation 138 of the cover/door is closed generated.

As can be appreciated, in various embodiments of the autonomous charging system 100 according to the present disclosure may include any number of additional sub-modules embedded within the charging station system which may be combined and/or further partitioned to similarly implement systems and methods described herein. Furthermore, inputs to the charging station system may be received from the sensor system, received from control modules (not shown) associated with the autonomous vehicle 10, received from the communication system 36, and/or determined/modeled by other sub-modules (not shown) within the charging station system. Furthermore, the inputs might also be subjected to preprocessing, such as sub-sampling, noise-reduction, normalization, feature-extraction, missing data reduction, and the like.

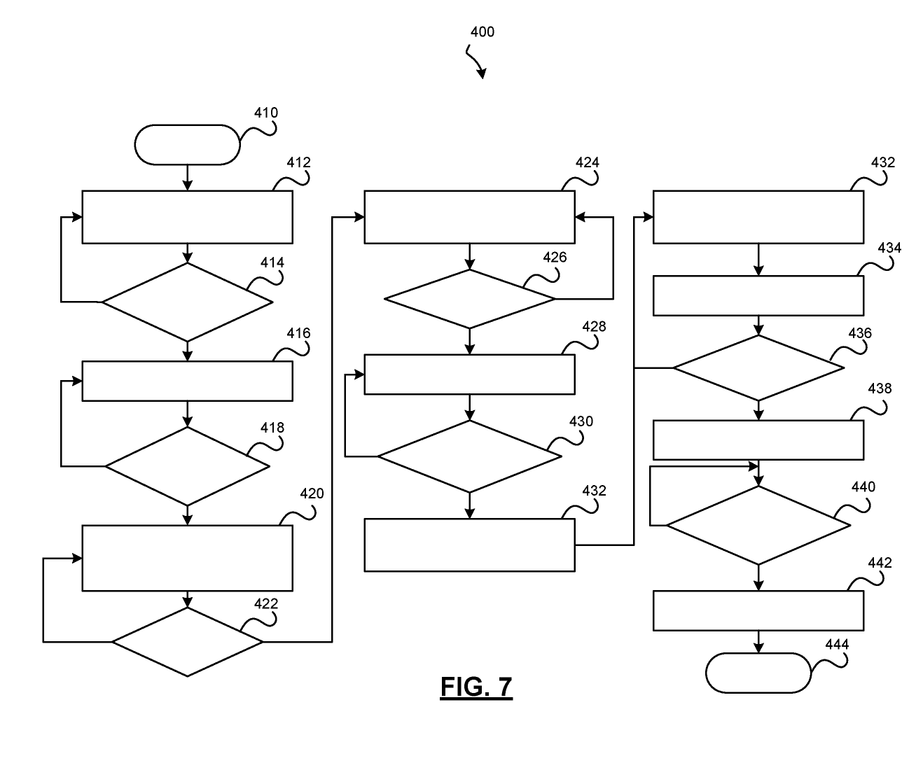

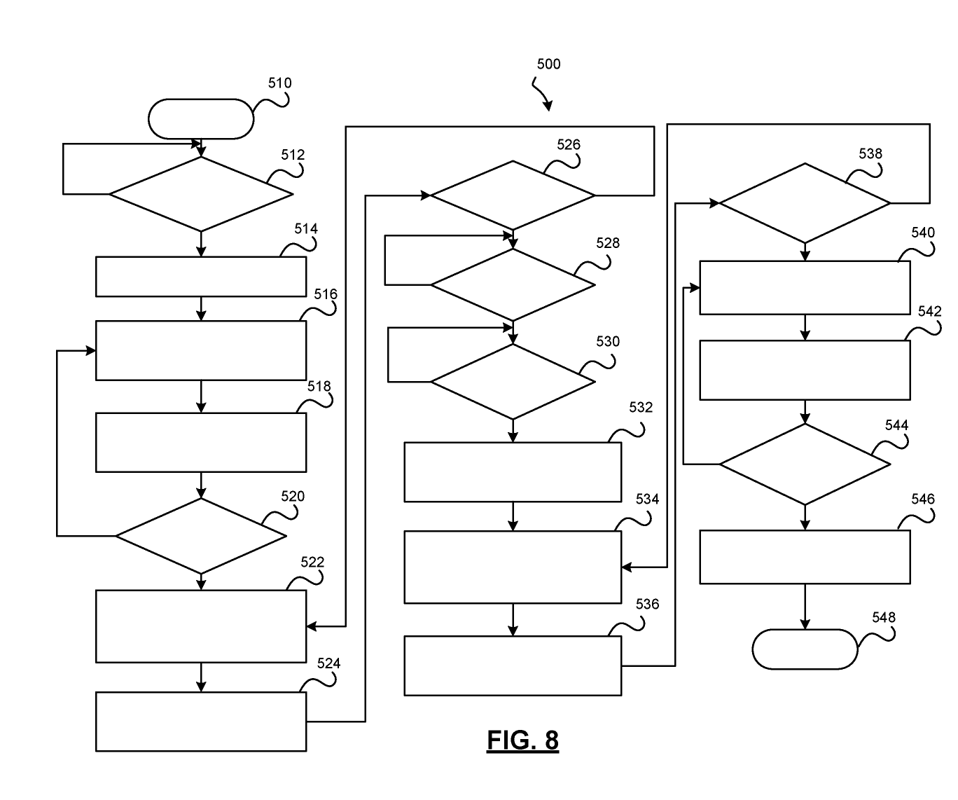

Referring now to FIG. 7-8, and with continued reference to FIGS. 1-6, flowcharts illustrate control methods 400 and 500 that can be performed by the autonomous charging system 100 of FIGS. 1 and 2 in accordance with the present disclosure. As can be appreciated in light of the disclosure, the order of operation within the method is not limited to the sequential execution as illustrated in FIGS. 7-8, but may be performed in one or more varying orders as applicable and in accordance with the present disclosure. In various embodiments, the methods 400 and 500 can be scheduled to run based on one or more predetermined events, and/or can run continuously during operation of the autonomous vehicle 10.

In various embodiments, the method 400 may be performed by the vehicle 10 and the method 500 may be performed by the charging station system. With particular reference to FIG. 7, the method 400 may begin at 410. Thereafter, the state of charge 102 of the battery is determined and evaluated at 412 and 414. If the state of charge 102 is less than a threshold at 414, the method continues with monitoring determining the state of charge at 412. If, however, the state of charge 102 is greater than the threshold at 414, the request to charge 104 is communicated to the reservation system at 416. Thereafter, communications are monitored for confirmation data 110 including a charging schedule at 418.

Once the confirmation data 110 is received at 418, the vehicle 10 is autonomously navigated to the charging station location and the charging slot location designated by the charging schedule of the confirmation data 110 at 420. Once it is determined that the vehicle 10 reaches the location of the charging station 53 and the location of the slot at 422, the vehicle 10 is autonomously navigated to the position in the slot for charging at 424. Once it is determined that the vehicle 10 reaches the position of the slot at 426, the state of charge 102 of the battery is determined at 428 and monitored at 430.

Once a change in the state of charge 102 is greater than a threshold at 430, the confirmation of the charging initiated is communicated to the charging station system at 432. The state of charge is determined at 432 and a charging threshold is determined at 434. Thereafter, the state of charge is compared to the charging threshold at 436. Once the state of charge reaches the threshold at 436, the confirmation of charging complete is communicated to the charging station system at 438. Thereafter, communications are monitored for the cover/door closed confirmation at 440. Once the cover/door closed confirmation is received at 440, the vehicle 10 is controlled to a ready state at 442 and the method may end at 444.

With particular reference to FIG. 8, the method may begin at 510. Communications are monitored for the slot position confirmation 130 at 512. Once the slot position confirmation 130 is received at 512, the vehicle type is determine at 514 and control signals 158 are generated based on the vehicle type to open the door/cover of the vehicle body 14 at 516. Sensor data 160 is processed to determine whether the door/cover is completely open at 518. If it is not confirmed that the cover/door is completely open at 520, the method continues with generating control signals 158 to open the door/cover at 516, and process the sensor data 160 at 518.

Once it is confirmed that the cover/door is open at 520, control signals 164 are generated based on the vehicle type to select the connector device 68 and insert the connector device 68 into the port of the vehicle 10 at 522. Sensor data 166 is processed to determine whether the connector device insertion is complete at 524. If it is not confirmed that the connector device 68 is completely inserted at 526, the method continues with generating control signals 164 to insert the connector device 68 at 522 and process the sensor data 166 at 524.

Once it is confirmed that the connector device 68 is inserted at 526, communications are monitored for the charging initiated confirmation 132/134 at 528. Once charging is initiated at 528, communications are monitored for the charging complete confirmation 136 at 530. Once charging is complete at 530, charging complete is confirmed within the charging station system 83 at 532. Control signals 170 are generated based on the vehicle type to remove the connector device 68 from the port at 534. Sensor data 172 is processed to determine whether the connector device 68 is completely removed at 536. If it is not confirmed that the connector device 68 is completely removed at 538, the method continues with generating control signals 170 to remove the connector device 68 at 534 and process the sensor data 172 at 536.

Once it is confirmed that the connector device 68 is completely removed at 538, control signals 176 are generated based on the vehicle type to close the door/cover at 540. Sensor data 178 is processed to determine whether the door/cover is completely closed at 542. If it is not confirmed that the cover/door is completely closed at 544, the method continues with generating control signals 176 to close the door/cover at 540 and process the sensor data 178 at 542.

Once it is confirmed that the cover/door is closed at 544, the cover/door closed confirmation 138 is generated and communicated to the vehicle 10 at 546. Thereafter, the method may end at 548.

As can be appreciated, in any instance where the methods 400 and 500 await a communication to be received and the communication is not received within a defined time period, follow-up requests for information may generated in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, comprising:
determining, by a processor, a state of charge of batteries of the vehicle;
autonomously controlling, by a processor, the vehicle to a slot of a charging station based on the state of charge; and
communicating, by a processor, with the charging station to coordinate autonomous charging of the batteries of the vehicle.

2. The method of claim 1, further comprising communicating with a remote transportation system to reserve a charging time associated with the slot of the charging station.

3. The method of claim 1, confirming a position of the vehicle within the slot based on sensor data.

4. The method of claim 3, wherein the sensor data includes image data.

5. The method of claim 1, further monitoring the state of charge of the batteries while the charging station is coordinating the autonomous charging of the batteries; and generating a charging confirmation to the charging station based on the monitoring.

6. A method of charging batteries of a vehicle, comprising:
receiving, by a processor, a communication from a vehicle positioned in a slot associated with a charging system; and
in response to the receiving, coordinating, by a processor, autonomous charging of the batteries of the vehicle by generating one or more control signals to an extension arm associated with the charging system.

7. The method of claim 6, wherein the coordinating comprises generating control signals to the extension arm such that the extension arm opens a cover or door associated with the charging system.

8. The method of claim 7, further comprising processing sensor data from a sensor associated with the extension arm to confirm the opening of the cover or door.

9. The method of claim 6, wherein the coordinating comprises generating control signals to the extension arm such that the extension arm inserts a connector device associated with the charging system into a port of the vehicle.

10. The method of claim 9, further comprising processing sensor data from a sensor associated with the extension arm to confirm the insertion of the connector device into the port.

11. The method of claim 6, wherein the coordinating comprises generating controls signals to the extension arm such that the extension arm closes a cover or door associated with the charging system.

12. The method of claim 11, further comprising processing sensor data from a sensor associated with the extension arm to confirm the closing of the cover or door.

13. The method of claim 6, wherein the communication comprises a confirmation of a position within the slot.

14. The method of claim 6, wherein the communication comprises a vehicle identifier.

15. The method of claim 6, wherein the communication comprises a confirmation of charging initiated.

16. The method of claim 6, wherein the communication comprises a confirmation of charging completed.

17. A system for charging batteries of a vehicle, comprising:
a power source;
at least one connector device coupled to the power source; and
a programmable machine having an extension arm, and a non-transitory module configured to, by a processor, generate one or more control signals to the extension arm such that the extension arm interacts with the connector device and the vehicle to charge the batteries of the vehicle.

18. The system of claim 17, wherein the non-transitory module generates control signals that cause the extension arm to open or close a door or cover of the vehicle.

19. The system of claim 17, wherein the non-transitory module generates control signals that cause the extension arm to insert a connector device into a port of the vehicle.

20. The system of claim 17, wherein the non-transitory module generates control signals that cause the extension arm to remove a connector device from a port of the vehicle.
